(19) United States
(12) Patent Application Publication
(10) Pub. No.: US 2015/0076049 A1
(43) Pub. Date: Mar. 19, 2015

(54) MICROFILTER AND APPARATUS FOR SEPARATING A BIOLOGICAL ENTITY FROM A SAMPLE VOLUME

(71) Applicant: Agency for Science, Technology and Research, Singapore (SG)

(72) Inventors: Sunil Kumar Arya, Singapore (SG); Abdur Rub Abdur Rahman, Singapore (SG); Chandran Jegatha, Singapore (SG); Chee Chung Wong, Singapore (SG)

(73) Assignee: Agency for Science, Technology and Research, Singapore (SG)

(21) Appl. No.: 14/395,635

(22) PCT Filed: Apr. 19, 2013
(86) PCT No.: PCT/SG2013/000157

§ 371 Date: Oct. 20, 2014

(30) Foreign Application Priority Data
Apr. 20, 2012 (SG) SG201202941.9

(51) Int. Cl. G01N 1/40

(52) U.S. Cl. CPC G01N 1/4077; G01N 2001/4088
USPC 210/223

(57) ABSTRACT

According to embodiments of the present invention, a microfilter is provided. The microfilter includes a first porous layer and a second porous layer arranged one over the other, wherein the first porous layer includes a plurality of first pores defined through the first porous layer, wherein the second porous layer includes a plurality of second pores defined through the second porous layer, and wherein one or more respective second pores are arranged to at least substantially overlap with each respective first pore such that a respective opening defined between a perimeter of the each respective first pore and a perimeter of each of the one or more respective second pores is smaller than a diameter of each first pore. According to further embodiments of the present invention, an apparatus for separating a biological entity from a sample volume is also provided.

### CROSS-REFERENCE TO RELATED APPLICATION

This application claims the benefit of priority of Singapore patent application No. 201202941-9, filed 20 Apr. 2012, the content of it being hereby incorporated by reference in its entirety for all purposes.

### TECHNICAL FIELD

Various embodiments relate to a microfilter, a microfilter array and an apparatus for separating a biological entity from a sample volume.

### BACKGROUND

Detection of circulating tumor cells (CTCs) has emerged as a promising minimally invasive diagnostic and prognostic tool for patients with metastatic cancer. CTCs are prognostically critical, associated with clinical stage, disease recurrence, tumor metastasis, treatment response, and patient survival following therapy. It has been shown that patients with metastatic breast cancer having more than five CTCs per 7.5 mL of blood have a much lower survival rate than patients with fewer cells. However, the technical challenge in detecting CTCs in peripheral blood lies in the rarity of these cells and non-existence of efficient technology for their enrichment with high sensitivity and precision. The number of CTC may be 1 CTC in about 10¹⁰ blood cells, which makes an effective separation or enrichment step challenging yet crucial for further diagnosis. Therefore, for any testing, efficient enrichment is a prerequisite.

CTC detection involves two separate steps, a) enrichment of cells from blood and b) detection by various means. Between these steps, the protocols may be laborious, involve biological labels and various sources of error.

Various protocols have been described in literature to enrich the CTCs from large volumes of blood. Some of the approaches in CTC enrichment and detection include immunomagnetic and immunofluorescent, microposts with immunity affinity based enrichment, 2D filter based techniques and 3D filter based techniques. Among these, immunomagnetic separation is the most widely used followed by size based separation. However, the immunomagnetic and immunofluorescent process is time consuming and subjective, and interpreting the immunofluorescent staining results requires a trained pathologist.

Recently, epithelial cell adhesion molecule (anti-EpCAM) coated microfabricated structures have gained attention for the enrichment of CTCs. However, these methods have significant barriers, including multiple procedural steps, substantial human intervention, high cost and importantly lack of high capture efficiency.

Currently, CellSearch™ system from Veridex is an FDA-approved system for CTC level measurement. This method is based on the use of antibody specific to cancer cell surface marker and its use is limited by the heterogeneity of expression of target antigen. Further, the yield from the CellSearch™ system is reported to be low and new tech highly sensitive and unbiased methods to isolate and enumerate CTCs are under investigation.

Microfabricated structures and filters have been used for enrichment of CTCs. For example, microfabricated microposts based microchip, with immuno-affinity based enrichment, has been used for CTC enrichment. While viable CTCs with high purity may be obtained, however, they used anti-EpCAM for capture of the cells and the capture efficiency of the system is limited by variation in surface marker or antigen expression by CTCs, and that white blood cells (WBCs) with larger sizes give error in counting. Other approaches include the use of 1D channels/apertures for enrichment, 2D micro slots, circular filter, 2D or 3D filter based techniques, and microcavity. All of these methods required prefixing of CTCs for efficient enrichment, however, such fixation limits the use of enriched cells for further analysis. For example, 2D filter based techniques have been used, which may be suitable for CTC enumeration in blood from metastatic cancer patients with high recovery and short processing time, but such techniques require samples to be partially fixed, incompatible for further live cell interrogations. Furthermore, in conventional approaches using a filter array, only cell filtering can be performed and the cells have to be counted optically. Recently, 3D microfiltration has shown promise to provide a highly valuable tool for efficient CTC enrichment. 3D filter has been used for cell enrichment without prefixing. 3D filter, micro cavity based techniques and channels based techniques may be suitable for CTC enumeration in blood from metastatic cancer patients with high recovery and short processing time. However, in all the above mentioned techniques, cells were inseparable at the single cell level and label free counting was impossible. Improvements over the conventional approaches are required for recovery, label free counting and analysis.

Thus, there is a need for the development of reliable, efficient platform to isolate, enrich and characterize CTCs in blood. In view of the above, a 3D filter and/or an integrated system for efficient, cost effecting enrichment, and counting may be desirable.

### SUMMARY

According to an embodiment, a microfilter is provided. The microfilter may include a first porous layer and a second porous layer arranged one over the other, wherein the first porous layer includes a plurality of first pores defined through the first porous layer, wherein the second porous layer includes a plurality of second pores defined through the second porous layer, and wherein one or more respective second pores are arranged to at least substantially overlap with each respective first pore such that a respective opening defined between a perimeter of the each respective first pore and a perimeter of each of the one or more respective second pores is smaller than a diameter of each first pore.

According to an embodiment, a microfilter array is provided. The microfilter array may include a plurality of microfilters. Each microfilter may be as described above.

According to an embodiment, an apparatus for separating a biological entity from a sample volume is provided. The apparatus may include a reservoir configured to receive the sample volume, the reservoir including a filter configured to separate the biological entity from the sample volume, at least one of at least one magnetic element adjacent a portion of the reservoir, the magnetic element configured to provide a magnetic field in a vicinity of the portion of the reservoir to trap at least some of the leukocytes, or a layer including leukocyte specific biomarkers coated on at least a section of an inner wall of the reservoir, the leukocyte specific biomarkers configured to couple to leukocytes from the sample volume, and a plurality of microchannels coupled to the reservoir, each microchannel including an electrode structure configured to measure a change in an electrical signal in response to a flow of the separated biological entity through the microchannel.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic block diagram of a microfilter, according to various embodiments.

FIGS. 1B and 1C respectively show cross-sectional representations of the microfilter of the embodiment of FIG. 1A, according to various embodiments.

FIG. 2A shows a schematic block diagram of an apparatus for separating a biological entity from a sample volume, according to various embodiments.

FIG. 2B shows a scanning electron microscope (SEM) image of a filter, according to various embodiments.

FIGS. 3A and 3B show schematic cross sectional views of respective microfilters, according to various embodiments.

FIGS. 3C, 3D and 3E respectively show a cross-sectional view, a top view and a perspective see-through view of a microfilter, according to various embodiments.

FIG. 4A shows a schematic top view of a microfilter, according to various embodiments.

FIGS. 4B and 4C show schematic cross sectional and perspective views of respective microfilters, according to various embodiments.

FIGS. 5A to 5C show schematic views of respective integrated systems for cell enrichment and counting, according to various embodiments.

FIG. 6A shows a schematic perspective view of a tray for cell collection, according to various embodiments.

FIG. 6B shows a schematic top view of an assay kit, according to various embodiments.

FIG. 6C shows processing stages of an electrochemiluminescent assay, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element includes a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may relate to biosensor, for example relating to integrated microsystems for cell-based diagnostics, for example relating to circulating tumour cells (CTCs) in terms of diagnosis and therapy monitoring and/or endothelial progenitor cells (EPCs) for health monitoring.

Various embodiments may relate to a three-dimensional (3D) filter and/or an integrated system for tumor cell enrichment and label free counting. The filter and/or system may perform one or more of the functions of enrichment of circulating tumour cells (CTCs) and label free counting of CTCs.

Various embodiments may provide a standalone three-dimensional (3D) filter and a fully automated integrated system for rare cell enrichment and counting. The 3D filter may be an integrated 3D filter. The fully automated integrated system may employ the 3D filter. The 3D filter and/or the fully automated integrated system may be used for cell counting, for example counting of CTCs.

Various embodiments may provide an approach of rare circulating tumor cell (CTC) enrichment and counting using a standalone 3D filter for efficient enrichment and a fully automated integrated system for enrichment and counting. The standalone 3D filter may be circular (e.g. about 13 mm diameter) and may include two layers. The two-layer circular standalone 3D filter may be made of parylene membrane. The filter may include a 20 μm thick top layer of parylene membrane, which may include uniformly distributed 20 μm holes or pores, and a lower layer of parylene membrane including 8 μm holes or pores, and also of 20 μm thickness. In various embodiments, the design of the holes may allow the alignment of at least three 8 μm holes right beneath and within each 20 μm pore present in the top layer of the filter. Enrichment procedure may result in the isolation of each CTC or individual CTCs in separate pockets of 20 μm, filtering out smaller red blood cells (RBCs), and white blood cells (WBCs) through the lower array of 8 μm holes.

In various embodiments, the fully automated integrated system may contain two to three chambers and may also include an inbuilt pre-enrichment system, for filtration, enrichment, label free counting and cell collection via a combination of size based filtration, immune/imunomagnetic assay based enrichment and electrochemical impedance spectroscopy (EIS) based counting. The 3D filter as described herein may be employed in the fully automated integrated system.

The parylene based 3D filter of various embodiments has the potential to replace the presently used commercial filters for general filtration and CTC enrichment. On the other hand, the integrated system has the potential to provide a fully automated system for highly enriched, purified and precisely counted CTCs for further molecular analysis, for example via optical and/or electrochemical techniques.

Various embodiments of the 3D filter may enable capture of viable tumor cells based on the 3D design of the filter. The 3D designs of various embodiments of the filter may also provide for high throughput and label free enumeration at single cell level.

The 3D filtration, counting and analysis enabled by various embodiments integrate high throughput cell enrichment and label free cell counting in a single device.

Various embodiments may provide precise cell counting, and/or cell enrichment with enhanced enrichment efficiency, and/or cell enrichment and counting in a single device without the need for sample transfer, thereby reducing or minimising cell loss, and/or a platform capability for high throughput sensing.

Various embodiments may be used for at least one of circulating tumour cell (CTC) detection, endothelial progenitor cell (EPC) detection, or Maternal Fetal Cells (MFC) detection.

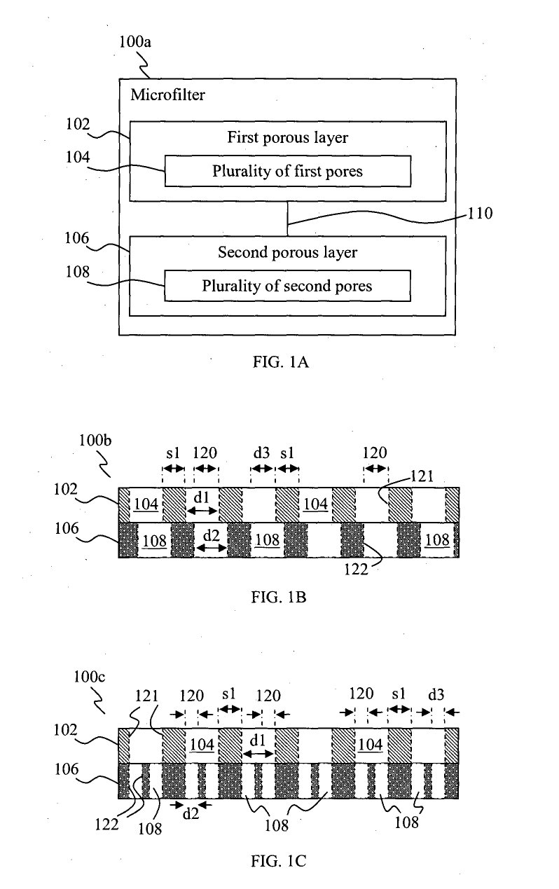

FIG. 1A shows a schematic block diagram of a microfilter 100a, while FIGS. 1B and 1C respectively show cross-sectional representations of the microfilter 100a of the embodiment of FIG. 1A, according to various embodiments. The microfilter 100a includes a first porous layer 102 and a second porous layer 106 arranged one over the other, wherein the first porous layer 102 includes a plurality of first pores 104 defined through the first porous layer 102, wherein the second porous layer 106 includes a plurality of second pores 108 defined through the second porous layer 106, and wherein one or more respective second pores 108 are arranged to at least substantially overlap with each respective first pore 104 such that a respective opening defined between a perimeter of the each respective first pore 104 and a perimeter of each of the one or more respective second pores 108 is smaller than a diameter (or dimension) of each first pore 104. In FIG. 1A, the line represented as 110 is illustrated to show the relationship between the first porous layer 102 with the plurality of first pores 104, and the second porous layer 106 with the plurality of second pores 108, which may include mechanical coupling and/or fluid communication relative to each other.

In other words, the microfilter 100a may include a two-layer arrangement of a first porous layer 102 and a second porous layer 106. The first porous layer 102 may include a plurality of first pores or openings 104, which may be distributed throughout the first porous layer 102. The second porous layer 106 may include a plurality of second pores or openings 108, which may be distributed throughout the second porous layer 106.

Each first pore 104 may be defined through the thickness or depth of the first porous layer 102, for example between and through opposed surfaces (e.g. top surface and bottom surface) of the first porous layer 102. Any one or each first pore 104 may be defined orthogonally to at least one of the top surface or the bottom surface of the first porous layer 102.

Each second pore 108 may be defined through the thickness or depth of the second porous layer 106, for example between and through opposed surfaces (e.g. top surface and bottom surface) of the second porous layer 106. Any one or each second pore 108 may be defined orthogonally to at least one of the top surface or the bottom surface of the second porous layer 106.

One or more respective second pores 108 may be arranged to at least substantially overlap or align with a respective first pore 104 such that a respective opening defined between a perimeter or edge of the each respective first pore 104 and a perimeter or edge of each of the one or more respective second pores 108 may be smaller than a diameter (or dimension) of each first pore 104. Using one first pore 104 and one second pore 108 as a non-limiting example, this may mean that a portion of a second pore 108 may overlap with a first pore 104, where this overlapping portion defines the opening. In this way, the microfilter 100a may enable filtration through the first pore 104, followed by filtration through the opening, having a diameter (or dimension) smaller than the diameter (or dimension) of the first pore 104, defined by the overlapping portion between the first pore 104 and the second pore 108, where the overlapping portion may be between the perimeter of the first pore 104 and the perimeter of the second pore 108.

In the context of various embodiments, the term “diameter” as applied to a first pore 104 and/or a second pore 108 may mean a dimension or cross sectional dimension of the first pore 104 and/or the second pore 108.

In the context of various embodiments, the term “perimeter” may mean an edge or a border or a circumference.

In various embodiments, the first porous layer 102 may be arranged over the second porous layer 106, where the first porous layer 102 may be the top layer of the microfilter 100a and the second porous layer 106 may be the bottom layer.

In the context of various embodiments of the microfilter 100a, each second pore 108 may have a diameter (or dimension) that may be smaller than the diameter (or dimension) of each first pore 104. In various embodiments, the one or more respective second pores 108 may be arranged to be within the perimeter of each respective first pore 104.

As shown in FIG. 1B for a non-limiting example corresponding to the microfilter 100a (FIG. 1A), in the form of the microfilter 100b, a second pore 108 may be arranged overlapping with a first pore 104, where the second pore 108 may be offset relative to the first pore 104 so as to define an opening 120 between the perimeter 121 of the first pore 104 and the perimeter 122 of the second pore 108. The first pore 104 may have diameter, d1, the second pore 108 may have diameter, d2, while the opening 120 may have diameter, d3. In various embodiments, d3<d1. In various embodiments, d1=d2.

As shown in FIG. 1C for a non-limiting example corresponding to the microfilter 100a (FIG. 1A), in the form of the microfilter 100c, one or more second pores 108 may be arranged overlapping with a first pore 104, where each second pore 108 may be arranged within the perimeter or circumference 121 of the first pore 104. Therefore, an opening 120 defined between the perimeter 121 of a first pore 104 and the perimeter 122 of a second pore 108 corresponds to the second pore 108. The first pore 104 may have diameter, d1, the second pore 108 may have diameter, d2, while the opening 120 may have diameter, d3. In various embodiments, d3<d1. In various embodiments, d2=d3.

In various embodiments, the first porous layer 102 may be arranged in contact with the second porous layer 106.

In various embodiments, the first porous layer 102 and the second porous layer 106 may be a continuous structure.

In various embodiments, the first porous layer 102 may be arranged spaced apart from the second porous layer 106 by a gap. The gap may be an air gap. In the context of various embodiments, the gap may be between about 1 μm and about 20 μm, for example between about 1 μm and about 10 μm, between about 1 μm and about 5 μm, between about 5 μm and about 20 μm, or between about 2 μm and about 5 μm. In various embodiments, the distance of the gap provided may depend on the cell types to be filtered.

In the context of various embodiments, the first porous layer 102 may have a thickness of between about 1 μm and about 20 μm, for example between about 1 μm and about 10 μm, between about 1 μm and about 5 μm, between about 5 μm and about 20 μm, between about 2 μm and about 5 μm, between about 10 μm and about 20 μm, or between about 15 μm and about 20 μm. However, it should be appreciated that the thickness of the first porous layer 102 is not so limited and that other thicknesses may be possible, for example depending on the cell types to be filtered or passed through.

In the context of various embodiments, the second porous layer 106 may have a thickness of between about 1 μm and about 20 μm, for example between about 1 μm and about 10 μm, between about 1 μm and about 5 μm, between about 5 μm and about 20 μm, between about 2 μm and about 5 μm, or between about 10 μm and about 20 μm. However, it should be appreciated that the thickness of the second porous layer 106 is not so limited and that other thicknesses may be possible, for example depending on the cell types to be filtered or passed through.

In the context of various embodiments, each first pore 104 may have a diameter (or dimension) between about 5 μm and about 30 μm, for example between about 5 μm and about 20 μm, between about 5 μm and about 10 μm, between about 10 μm and about 30 μm, between about 10 μm and about 20 μm, or between about 20 μm and about 25 μm. However, it should be appreciated that the diameter (or dimension) of each first pore 104 is not so limited and that other diameters (or dimensions) may be possible, for example depending on the cell types to be filtered or passed through.

In the context of various embodiments, each second pore 108 may have a diameter (or dimension) between about 0.5 μm and about 15 μm, for example between about 0.5 μm and about 10 μm, between about 0.5 μm and about 8 μm, between about 0.5 μm and about 5 μm, between about 5 μm and about 15 μm, between about 8 μm and about 15 μm, or between about 8 μm and about 10 μm. However, it should be appreciated that the diameter (or dimension) of each second pore 108 is not so limited and that other diameters (or dimensions) may be possible, for example depending on the cell types to be filtered or passed through.

In the context of various embodiments, each opening 120 may have a diameter (or dimension) between about 0.5 μm and about 15 μm, for example between about 0.5 μm and about 10 μm, between about 0.5 μm and about 8 μm, between about 0.5 μm and about 5 μm, between about 5 μm and about 15 μm, between about 8 μm and about 15 μm, or between about 8 μm and about 10 μm. However, it should be appreciated that the diameter (or dimension) of each opening 120 is not so limited and that other diameters (or dimensions) may be possible, for example depending on the cell types to be filtered or passed through.

In the context of various embodiments, the plurality of first pores 104 may be spaced apart relative to each other by a spacing or inter-hole spacing, s1. In the context of various embodiments, s1 may be between about 1 μm and about 20 μm, for example between about 1 μm and about 10 μm, between about 1 μm and about 6 μm, between about 1 μm and about 5 μm, between about 5 μm and about 15 μm, between about 8 μm and about 20 μm, or between about 8 μm and about 10 μm. However, it should be appreciated that the spacing, s1, between adjacent first pores 104 relative from each other or in other words, the inter-hole spacing, s1, is not so limited and that other spacings (or dimensions) may be possible, for example depending on the membrane material strength and the required application.

In various embodiments, the plurality of first pores 104 may be uniformly distributed on or in the first porous layer 102 and/or the plurality of second pores 108 may be uniformly distributed on or in the second porous layer 106.

In various embodiments, three second pores 108 may be arranged to at least substantially overlap with each (or respective) first pore 104. The three second pores 108 may be completely arranged within the perimeter of each (or respective) first pore 104 beneath the each (or respective) first pore 104. The three second pores 108 may be arranged in a form resembling ‘Y’.

In various embodiments, five second pores 108 may be arranged to at least substantially overlap with each (or respective) first pore 104. The five second pores 108 may be completely arranged within the perimeter of each (or respective) first pore 104 beneath the each (or respective) first pore 104. The five second pores 108 may be arranged in a form resembling ‘X’.

It should be appreciated that the number of second pores 108 and/or their arrangement to at least substantially overlap with each (or respective) first pore 104 may vary, depending on the applications for the microfilters 100a, 100b, 100c.

In various embodiments, the first porous layer 102 may have a top surface and a bottom surface, and wherein the second porous layer 106 may have a top surface and a bottom surface, the top surface of the second porous layer 106 facing the bottom surface of the first porous layer 102, and wherein the top surface of the first porous layer 102 may include a metal layer. In various embodiments, the top surface of the second porous layer 106 may include a metal layer, and/or the bottom surface of the first porous layer 102 may include a metal layer. Each metal layer of or at the top surface of the first porous layer 102, the bottom surface of the first porous layer 102, and the top surface of the second porous layer 106 may include, but not limited to, a metal selected from the group of gold (Au), silver (Ag) and copper (Cu). It should be appreciated that other metals may be used.

In the context of various embodiments, each first pore 104 may have a shape selected from the group consisting of a circle, an oval, a hexagon, a square and a rectangle and/or each second pore 108 may have a shape selected from the group consisting of a circle, an oval, a hexagon, a square and a rectangle. However, it should be appreciated that each first pore 104 and/or each second pore 108 may be of any polygonal shape.

In the context of various embodiments, the first porous layer 102 and/or the second porous layer 106 may include a polymer (e.g. parylene) or a metal or a metal oxide or a metal nitride or silicon (e.g. silicon-on-insulator (SOI) or a silicon derivate, e.g. silicon oxide (SiO₂) or silicon nitride (Si₃N₄)) or SU-8. It should be appreciated that other spin-coatable and/or curable polymers and materials commonly used in silicon microfabrication may also be used.

In the context of various embodiments, it should be appreciated that the number and/or the arrangement of the plurality of first pores 104 and/or the shape of each first pore 104, and/or the number and/or the arrangement of the plurality of second pores 108 and/or the shape of each second pore 108 may vary, depending on the applications for the microfilters 100a, 100b, 100c.

In the context of various embodiments, a respective perimeter, edge or border of each of the first porous layer 102 and the second porous layer 106 may be coupled to each other, for example bonded to each other.

Various embodiments may also provide a microfilter array. The microfilter array may include a plurality of microfilters. Each of the microfilters may be as described in the context of the embodiment of the microfilter 100a (FIG. 1A), 100b (FIG. 1B) or 100c (FIG. 1C).

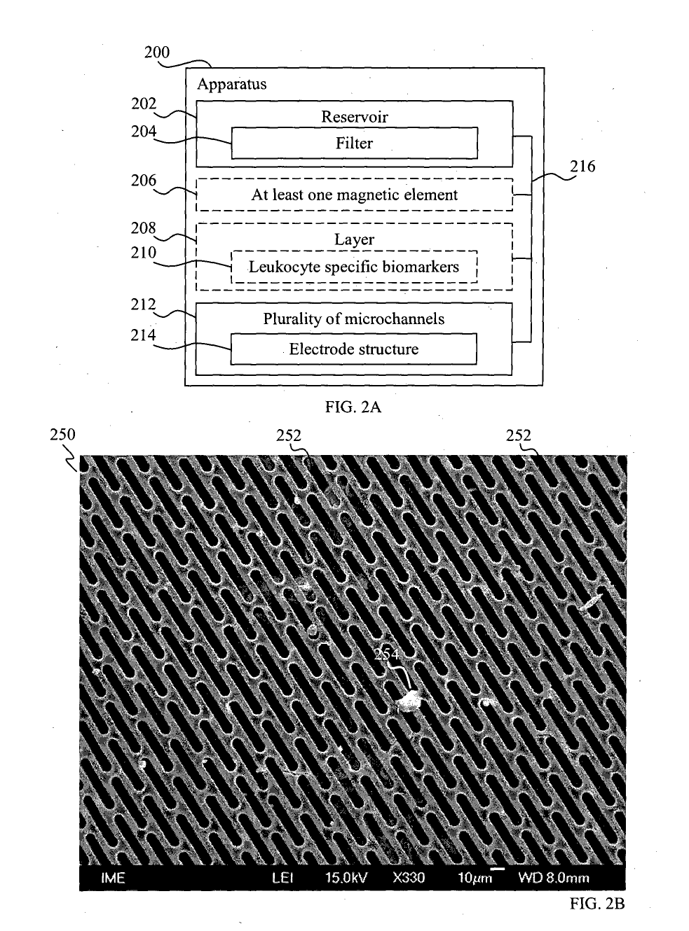

FIG. 2A shows a schematic block diagram of an apparatus 200 for separating a biological entity from a sample volume (e.g. a blood sample volume), according to various embodiments. The apparatus 200 includes a reservoir 202 configured to receive the sample volume, the reservoir 202 including a filter 204 configured to separate the biological entity from the sample volume, at least one of at least one magnetic element 206 adjacent a portion of the reservoir 202, the magnetic element 206 configured to provide a magnetic field in a vicinity of the portion of the reservoir 202 to trap at least some leukocytes from the sample volume, or a layer 208 including leukocyte specific biomarkers 210 coated on at least a section of an inner wall of the reservoir 202, the leukocyte specific biomarkers 210 configured to couple to leukocytes from the sample volume, and a plurality of microchannels 212 coupled to the reservoir 202, each microchannel 212 including an electrode structure 214 configured to measure a change in an electrical signal in response to a flow of the separated biological entity through the microchannel 212. In FIG. 2A, the line represented as 216 is illustrated to show the relationship between the reservoir 202 with the filter 204, the at least one magnetic element 206, the layer 208 with the leukocyte specific biomarkers 210, and the plurality of microchannels 212 with the electrode structures 214, which may include mechanical coupling and/or fluid communication relative to each other.

In other words, the apparatus 200 may include a reservoir 202, with a filter 204 incorporated therein. The filter 204 may retain the biological entity of interest, e.g. circulating tumour cells (CTCs) at the filter 204, while selectively allowing other materials, e.g. red blood cells (RBCs), leukocytes (white blood cells, WBCs), platelets, to pass through the filter 204. Therefore, the filter 204 may serve to separate the biological entity from other blood constituents present in the sample volume. The apparatus 200 may further include at least one magnetic element 206 positioned adjacent a portion of the reservoir 202, and/or a layer 208 including leukocyte specific biomarkers (e.g. antibodies) 210 coated on at least a section of an inner wall of the reservoir 202. The magnetic element 206 and/or the leukocyte specific biomarkers 210 may trap leukocytes (white blood cells) that may be present in the sample volume, within the reservoir 202. The leukocytes present in the sample volume may be attached with magnetic beads. Therefore, by means of the at least one magnetic element 206 generating a magnetic field in a vicinity of the portion of the reservoir 202 for trapping at least some of the leukocytes from the sample volume, and/or the leukocyte specific biomarkers 210 coated on at least a section of an inner wall of the reservoir 202 for trapping at least some of the leukocytes from the sample volume, the sample volume that flows out of the reservoir 202 may be at least substantially depleted of leukocytes as the leukocytes may remain within the reservoir 202. Subsequently, the enriched sample, containing predominantly the biological entity of interest and at least substantially depleted of WBCs and RBCs, may be passed through the plurality of microchannels 212 coupled to and/or in fluid communication with the reservoir 202, where the flow or passage of the biological entity through an electrode structure 214 may cause a change in the electrical signal measurable by the electrode structure 214.

In the context of various embodiments, the “biological entity” may include but not limited to a circulating tumour cell (CTC), a fetal cell or a stem cell.

In the context of various embodiments, the sample volume may be a blood sample, urine, or other bodily fluids.

In the context of various embodiments, the term “reservoir” may include a well or a chamber or a container.

In the context of various embodiments, the at least one magnetic element 206 may be movable. In the context of various embodiments, the at least one magnetic element 206 may include or may be a permanent magnet or an electromagnet, which may be activated and deactivated when necessary.

In the context of various embodiments, the term “leukocyte specific biomarkers” may mean biomarkers (e.g. antibodies) that may selectively couple or attach or bind to leukocytes. In the context of various embodiments, each of the leukocyte specific biomarkers 210 may include but not limited to anti-CD45 specific antibodies.

In various embodiments, the layer 208 may be coated throughout the inner wall of the reservoir 202. In various embodiments, the reservoir 202 may have a plurality of inner walls (e.g. sidewalls) and the layer 208 may be coated on at least a section of a respective inner wall or throughout a respective inner wall. The layer 208 may be coated on all the inner walls.

In various embodiments, the magnetic element 206 may be arranged to at least substantially surround the portion of the reservoir 202. In various embodiments, the magnetic element 206 may be arranged to at least substantially surround the reservoir 202 throughout the length of the reservoir 202.

In various embodiments, the reservoir 202 may further include a plurality of magnetic beads couplable to or configured to couple to leukocyte specific biomarkers configured to couple to the leukocytes from the sample volume. For example, antibody may be conjugated to the cells (e.g. leukocytes) by mixing the antibody solution with the sample volume, and then the magnetic beads may be conjugated to the antibody. When the magnetic element 206 is arranged to be adjacent a portion of the reservoir 202, the magnetic beads may be trapped by the magnetic field induced by the magnetic element 206. In various embodiments, the plurality of magnetic beads may be coated with leukocyte specific biomarkers configured to couple to the leukocytes from the sample volume.

In various embodiments, the reservoir 202 may be a chamber (e.g. a single chamber) including the filter 204, and where at least one magnetic element 206 may be arranged adjacent a portion of the chamber, the magnetic element 206 configured to provide a magnetic field in a vicinity of the portion of the chamber to trap at least some of the leukocytes, and/or a layer 208 including leukocyte specific biomarkers 210 coated on at least a section of an inner wall of the chamber, the leukocyte specific biomarkers 210 configured to couple to leukocytes from the sample volume.

In various embodiments, the reservoir 202 may include a first chamber and a second chamber in fluid communication with each other, wherein the first chamber may include the filter 204, and wherein the at least one magnetic element 206 may be arranged adjacent a portion of the second chamber and/or the layer 208 including the leukocyte specific biomarkers 210 may be coated on at least a section of an inner wall of the second chamber. In other words, separate chambers may be provided, one chamber (e.g. the first chamber) including a filter 204 for size-based filtration and another chamber (e.g. the second chamber) for removing leukocytes based on immuno-affinity and/or immunomagentic approaches. Alternatively, the at least one magnetic element 206 may be arranged adjacent a portion of the first chamber.

In various embodiments, the electrode structure 214 may include a first electrode and a second electrode spaced apart by a gap along a length of the microchannel 212. This may mean that the first electrode and the second electrode may be arranged along the length of the microchannel 212, and spaced apart from each other by a gap. In the context of various embodiments, the gap between the first electrode and the second electrode may be between about 1 μm and about 30 μm, for example between about 1 μm and about 20 μm, between about 1 μm and about 10 μm, between about 1 μm and about 5 μm, between about 10 μm and about 30 μm, between about 10 μm and about 20 μm, between about 5 μm and about 30 μm, or between about 5 μm and about 10 μm.

In the context of various embodiments, each of the first electrode and the second electrode may have a size of between about 1 μm and about 30 μm, for example between about 1 μm and about 20 μm, between about 1 μm and about 10 μm, between about 1 μm and about 5 μm, between about 10 μm and about 30 μm, between about 10 μm and about 20 μm, between about 5 μm and about 30 μm or between about 5 μm and about 10 μm.

In the context of various embodiments, each of the first electrode and the second electrode may have a thickness of between about 1 μm and about 30 μm, for example between about 1 μm and about 20 μm, between about 1 μm and about 10 μm, between about 1 μm and about 5 μm, between about 10 μm and about 30 μm, between about 10 μm and about 20 μm, between about 5 μm and about 30 μm or between about 5 μm and about 10 μm.

In various embodiments, the apparatus 200 may further include a pump coupled to the reservoir 202, the pump configured to provide a suction force. The suction force may be employed to remove blood constituents other than the biological entity, for example WBCs and RBCs, from the reservoir 202.

In various embodiments, the apparatus 200 may further include an output chamber in fluid communication with the plurality of microchannels 212, the output chamber configured to receive the separated biological entity after filtration through the filter 204. This may mean also that the output chamber may receive the separated biological entity after passage of the biological entity through the microchannels 212.

In the context of various embodiments, the filter 204 may be a one-dimensional (1D), two-dimensional (2D) or three-dimensional filter (3D), with ordered polygonal shapes or structures. The filter 204 may be microfabricated (i.e. a microfabricated filter), for example using lithography.

In the context of various embodiments, the filter 204 may be the microfilter as described in the context of the embodiments of FIGS. 1A to 1C.

In the context of various embodiments, the filter 204 may be included in a microfluidic device. The filter 204 may be integrated in the microfluidic device. The microfluidic device may be at least substantially transparent. The microfluidic device may be made of a plastic or a polymer, e.g. polymethyl methacrylate (PMMA).

In the context of various embodiments, the filter 204 may be a single layer filter or may include a single porous layer, including a plurality of pores, where each pore may have a diameter or dimension of between about 0.5 μm and about 30 μm, for example between about 0.5 μm and about 20 μm, between about 0.5 μm and about 10 μm, between about 0.5 μm and about 5 μm, between about 1 μm and about 10 μm, between about 5 μm and about 30 μm or between about 5 μm and about 10 μm.

As a non-limiting example, the filter 204 may be of the form as shown in FIG. 2B, which shows a scanning electron microscope (SEM) image of a filter 250 having a porous layer including a plurality of pores 252. Each pore 252 may be an elongate pore or a slit. Each slit 252 may have a dimension or a width of about 6 μm and a length of about 40 μm. As illustrated in FIG. 2B, a biological entity (e.g. a tumour cell, a CTC) 254 is captured or retained by the filter 250.

It should be appreciated that slits of other dimensions may be provided, for example each slit 252 may have a width of between about 4 μm and about 6 μm, for example between about 4 μm and about 5.5 μm or between about 5 μm and about 6 μm, and/or a length of between about 20 μm and about 50 μm, for example between about 20 μm and about 40 μm, between about 20 μm and about 30 μm or between about 40 μm and about 50 μm.

The rectangular slit or elongate pore 252 may help to alleviate the pressure that may be built up on the cells, as the cells may not fully occupy the porous structure. RBCs, being 1000-times more deformable, may easily re-orient themselves to pass through the opening or pore 252 while nucleated cells may not pass through easily. Hence, the rectangular slit design may maximize the flow rate while minimizing the required pressure to drive the flow. This may preserve the viability and morphology of target cells.

In the context of various embodiments, the filter 204 may include two layers. The filter 204 may include a first porous layer and a second porous layer arranged one over the other, wherein the first porous layer includes a plurality of first pores defined through the first porous layer, wherein the second porous layer includes a plurality of second pores defined through the second porous layer, and wherein one or more respective second pores may be arranged to at least substantially overlap with each respective first pore such that a respective opening defined between a perimeter of the each respective first pore and a perimeter of each of the one or more respective second pores may be smaller than a diameter (or dimension) of each first pore. Each second pore may have a diameter (or dimension) that is smaller than the diameter (or dimension) of each first pore. In various embodiments, the one or more respective second pores may be arranged to be within or completely within the perimeter of each respective first pore.

In various embodiments, the thickness of the first porous layer, and/or the thickness of the second porous layer, and/or the diameter (or dimension) of each first pore, and/or the diameter (or dimension) of each second pore may be as described in the context of the embodiments of FIGS. 1A to 1C.

In the context of various embodiments, the filter 204 may include a plurality of first channels arranged in a first row, and a plurality of second channels arranged in a second row adjacent to the first row, wherein one or more respective second channels may be arranged to at least substantially overlap with each respective first channel such that a respective opening defined between an edge of the each respective first channel and an edge of each of the one or more respective second channels may be smaller than a width of each first channel. In further embodiments, the filter 204 may further include a plurality of third channels arranged in a third row, wherein the second row may be arranged between the first row and the third row, and wherein one or more respective third channels may be arranged to at least substantially overlap with each respective second channel such that a respective opening defined between an edge of the each respective second channel and an edge of each of the one or more respective third channels may be smaller than a width of each second channel.

In the context of various embodiments, the layer 208 including the leukocyte specific biomarkers 210 may further include an azide (e.g. 4-azidoniline hydrochloride). The azide may also be or include, but not limited to, an amino azide or aldehydic azide or epoxy azide or aromatic-fluoro-nitro azide.

In the context of various embodiments, the term “coupled” may include a direct coupling and/or an indirect coupling. For example, two components being coupled to each other may mean that there is a direct coupling path between the two components and/or there is an indirect coupling path between the two components, e.g. via one or more intervening components.

The preparation for the layer 208 including the leukocyte specific biomarkers 210 will now be described by way of the following non-limiting example. A photoreactive substance may be physically deposited on at least a section of an inner wall or surface of the reservoir 202 through Azido chemistry. The reaction between the inner surfaces (e.g. polymer surfaces) of the reservoir 202 may occur steadily under ultraviolet (UV) exposure (e.g. at about 220 nm). Afterwhich, glutaraldehyde (GAD) and sodium cyanoborohydride may be used as further reagents to further enhance the functionalization by providing anchor sites for the capture of leukocyte specific biomarkers.

After functionalizing the surface to capture leukocyte specific biomarkers, the biomarkers 210 may be deposited in liquid phase by diluting it in liquid and incubating in the reservoir 202 as per the following surface treatment protocol for the treatment of the inner wall of the reservoir 202.

The surface treatment protocol may facilitate binding between a substrate (e.g. a plastic substrate), for example the reservoir 202, and antibody, hence capturing (or trapping) blood cells through antibody-antigen specific binding between proteins on blood cells. The procedure for the surface treatment may be as follows:
1. Mix about 0.5-1 mg of 4-azidoniline hydrochloride with ethanol.
2. Treat the surface (e.g. plastic surface) of the substrate with the azido-solution. This step should be operated in a substantially dark environment to minimize the unwanted reactions due to exposure of light.
3. Cure the sample for about 60 min at room temperature with gentle shaking.
4. Treat the surface under UV transilluminator (e.g. at about 220 nm) for about 10-30 min.
5. Wash the surface with ethanol, subsequently with de-ionised (DI) water.
6. Incubate the surface with 2% Glutaraldehyde for about 30 min.
7. Wash the surface with phosphate buffered saline (PBS).
8. Incubate the surface with leukocyte specific biomarker for about 30 min.
9. Wash the sample with PBS again.

Based on the surface treatment protocol, 4-azidoniline hydrochloride may be physically deposited on the surface (e.g. polymer/plastic surface) through evaporation of ethanol. Under UV light, the chemical reaction between the polymer and the chemical substance may occur steadily. Glutaraldehyde (GAD) may be used to enhance functionalization to provide more anchor-sites (chemical groups) for binding of antibody.

In further embodiments, the reservoir 202 may also be coated via spray coating of the leukocyte specific biomarkers 210 after surface activation, using spray coating means.

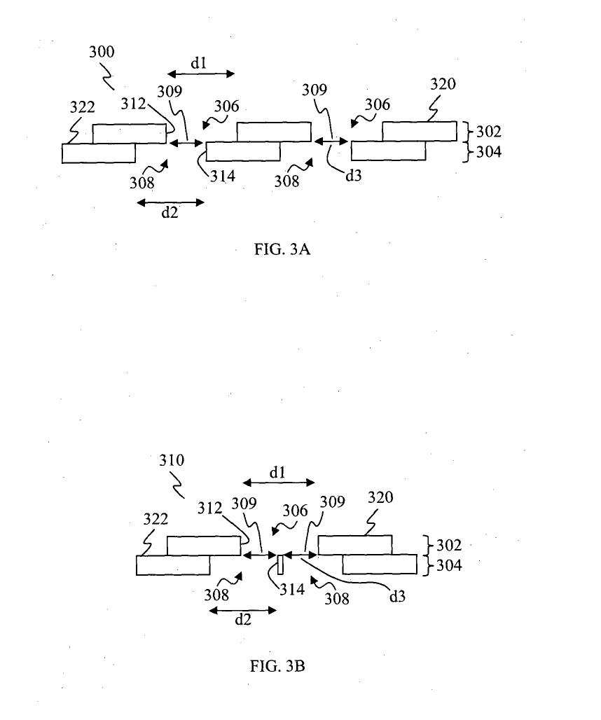

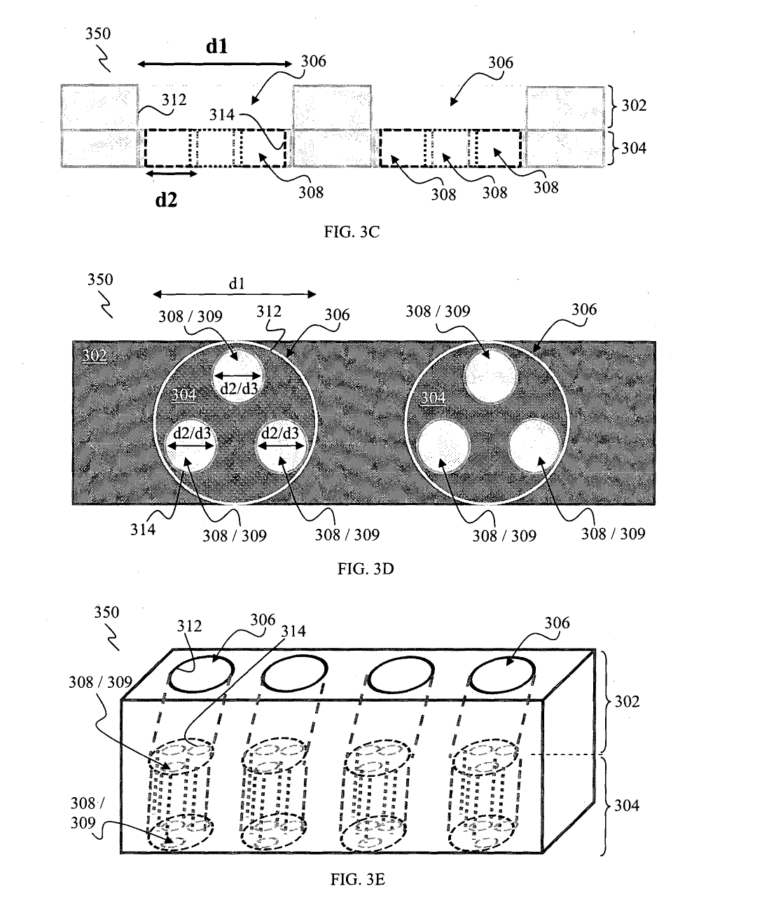

The microfilters of various embodiments will now be described by way of the following non-limiting examples. FIGS. 3A and 3B show schematic cross sectional views of respective microfilters 300, 310, according to various embodiments.

Each of the microfilters 300, 310 includes a first porous layer 302 and a second porous layer 304 arranged one over the other, wherein the first porous layer 302 includes a plurality of first pores 306 defined through the first porous layer 302, wherein the second porous layer 304 includes a plurality of second pores 308 defined through the second porous layer 304, wherein one or more respective second pores 308 are arranged to at least substantially overlap with each respective first pore 306 such that a respective opening 309 defined between a perimeter 312 of the each respective first pore 306 and a perimeter 314 of each of the one or more respective second pores 308 is smaller than a diameter (or dimension), d1, of each first pore 306. The opening 309 may have a diameter (or dimension), d3. Each second pore 308 may have a diameter (or dimension), d2.

As illustrated in FIG. 3A, one respective second pore 308 may be arranged to at least substantially overlap with each respective first pore 306 such that a respective opening 309 (of diameter or dimension, d3) defined between a perimeter 312 of the each respective first pore 306 and a perimeter 314 of the one respective second pore 308 is smaller than a diameter (or dimension), d1, of each first pore 306.

As illustrated in FIG. 3B, a plurality of respective second pores 308 may be arranged to at least substantially overlap with each respective first pore 306 such that a respective opening 309 (of diameter or dimension, d3) defined between a perimeter 312 of the each respective first pore 306 and a perimeter 314 of each of the plurality of respective second pores 308 is smaller than a diameter (or dimension), d1, of each first pore 306.

In various embodiments, each second pore 308 may have a diameter (or dimension), d2, that is equal to or smaller than the diameter (or dimension), d1, of each first pore 306.

In embodiments where each second pore 308 has a diameter (or dimension), d2, that is smaller than the diameter (or dimension), d1, of each first pore 306, the one or more respective second pores 308 may be arranged to be within the perimeter of each respective first pore 306, for example as illustrated for a microfilter 350 in FIGS. 3C, 3D and 3E, according to various embodiments.

The microfilter 350 includes a first porous layer 302 and a second porous layer 304 arranged one over the other, wherein the first porous layer 302 includes a plurality of first pores 306 defined through the first porous layer 302, wherein the second porous layer 304 includes a plurality of second pores 308 defined through the second porous layer 304, wherein one or more respective second pores 308 are arranged to at least substantially overlap with each respective first pore 306 such that a respective opening 309 defined between a perimeter 312 of the each respective first pore 306 and a perimeter 314 of each of the one or more respective second pores 308 is smaller than a diameter (or dimension), d1, of each first pore 306. Each second pore 308 has a diameter (or dimension), d2, that is smaller than the diameter (or dimension), d1, of each first pore. The opening 309 may have a diameter (or dimension), d3.

As illustrated in FIGS. 3C, 3D and 3E, the one or more respective second pores 308 (e.g. three second pores 308) may be arranged to be completely within the perimeter 312 of each respective first pore 306. It should be appreciated that the number of second pores 308 arranged to be within the perimeter 312 of each respective first pore 306 may vary, depending on the applications for the microfilter.

One or more diameters or dimensions corresponding to the microfilters 300, 310, 350, or the corresponding features thereof, may be as described in the context of the embodiments of FIGS. 1A to 1C.

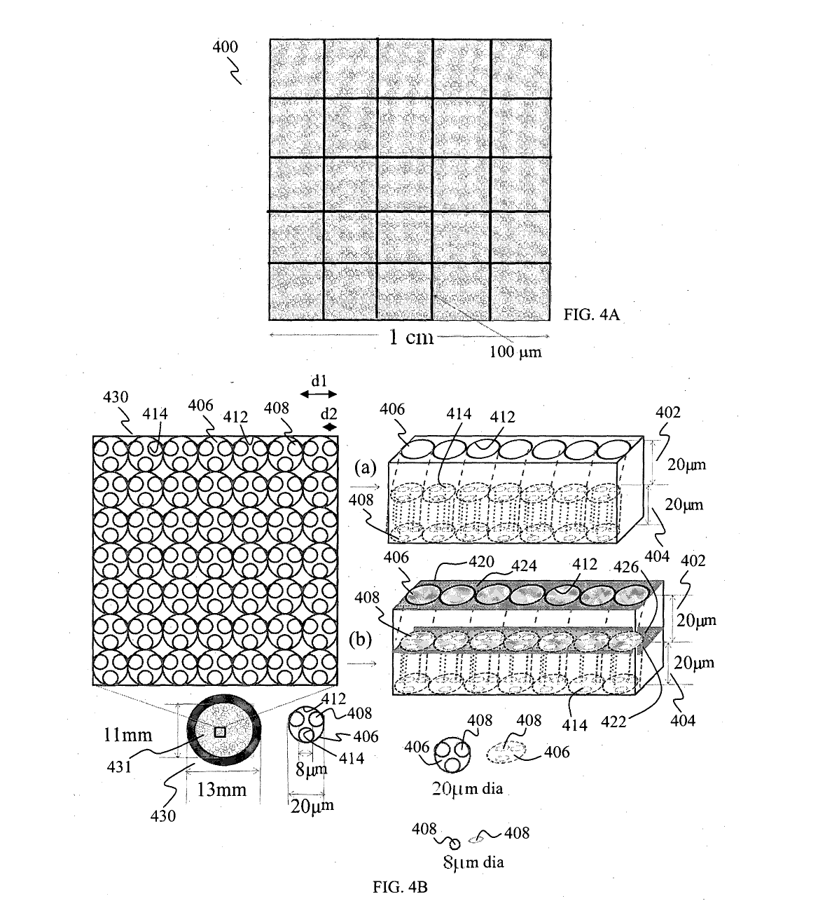

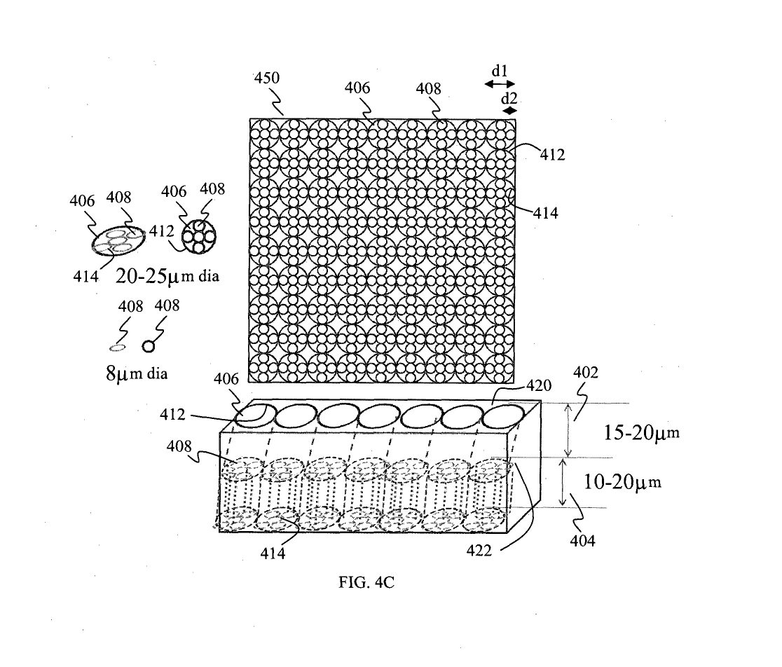

FIG. 4A shows a schematic top view of a microfilter 400, according to various embodiments. The microfilter 400 may be of a rectangular shape. The microfilter 400 may have a structure or arrangement as will be described in the context of the embodiments of FIG. 4B or FIG. 4C.

FIGS. 4B and 4C show schematic cross sectional and perspective views of respective microfilters 430, 450, according to various embodiments. Each microfilter 430, 450, may be made of parylene. Each microfilter 430, 450, may have a rectangular shape or a circular shape, for example as illustrated in FIG. 4B for the microfilter 430 with a diameter of about 13 mm and having an active region 431 of a diameter of about 11 mm for filtration.

Each of the microfilters 430, 450 includes a first porous layer 402 and a second porous layer 404 arranged one over the other, e.g. the first porous layer 402 is arranged over or on top of the second porous layer 404. The first porous layer 402 is in contact with the second porous layer 404. The first porous layer 402 and the second porous layer 404 may be a continuous structure. Each of the first porous layer 402 and the second porous layer 404 may be made of parylene.

The first porous layer 402 includes a plurality of first pores 406 defined through the first porous layer 402, where each first pore 406 may have a circular shape with a diameter d1. The second porous layer 404 includes a plurality of second pores 408 defined through the second porous layer 404, where each second pore 408 may have a circular shape with a diameter d2. d2 may be about 8 μm, while d1 may be between about 20 μm and about 25 μm, e.g. about 20 μm. Therefore, d2<d1.

As shown in FIGS. 4B and 4C, a respective second pore 408 is arranged within a perimeter 412 of a respective first pore 406. For the microfilter 430, three second pores 408 are arranged completely within the perimeter 412 of a respective first pore 406. Therefore, three second pores 408 are arranged to at least substantially overlap with a respective first pore 406, where the three second pores 408 may be arranged in a form resembling ‘Y’. For the microfilter 450, five second pores 408 are arranged completely within the perimeter 412 of a respective first pore 406. Therefore, five second pores 408 are arranged to at least substantially overlap with a respective first pore 406, where the five second pores 608 may be arranged in a form resembling ‘X’.

For the microfilters 430, 450, the respective opening defined between a perimeter 412 of a respective first pore 406 and a perimeter 414 of each of the plurality of respective second pores 408 may be equivalent to the respective second pore 408. This means that the opening has the diameter, d2, which is less than d1.

The first porous layer 402 may have a thickness of between about 15 μm and about 20 μm, while the second porous layer 404 may have a thickness of between about 10 μm and about 20 μm.

In one non-limiting example of the microfilter 430, each of the first porous layer (e.g. top layer) 402 and the second porous layer (e.g. bottom or lower layer) 404 may have a thickness of about 20 μm, with first pores 406 of a diameter of about 20 μm and second pores 408 of a diameter of about 8 μm, and with three second pores 408 confined within a 20 μm-pore 406 of the top layer 402.

In another non-limiting example of the microfilter 430, the first porous layer 402 may have a thickness of about 15 μm while the second porous layer 404 may have a thickness of about 10 μm, with first pores 406 of a diameter of about 20 μm and second pores 408 of a diameter of about 8 μm, and with three second pores 408 confined within a 20 μm-pore 406 of the top layer 402.

In addition, using the microfilter 430 as a non-limiting example and as illustrated in FIG. 4B, the top surface 420 of the first porous layer 402 may include a metal layer (e.g. Au) 424 and the top surface 422 of the second porous layer 404 may include a metal layer (e.g. Au) 426. By providing the metal layers 424, 426, electrochemical and electrochemiluminescence(ECL) based testing may be carried out.

The microfilters 400, 430, 450, may respectively be a cost-effective standalone 3D filter for efficient enrichment of cells such as CTCs. Each of the standalone 3D filters or microfilters 400, 430, 450, includes 2-layer parylene with photo-lithographically defined pores (first pores 406 and second pores 408) for specific or controlled and efficient size based filtration, e.g. of CTC from the rest of the blood cells. Such microfilters 400, 430, 450 may have the potential to replace most commonly used commercial filters, including track etch filters. In addition, a microfilter (e.g. 400, 430, 450) with a metal layer (e.g. 424, 426) on each parylene layer (e.g. 402, 404), for example as illustrated in FIG. 4B, may provide the possibility of using the same microfilter for further analysis via optical, electrochemical or via electrochemiluminescence (ECL) imaging at a single cell level, for example including using beads.

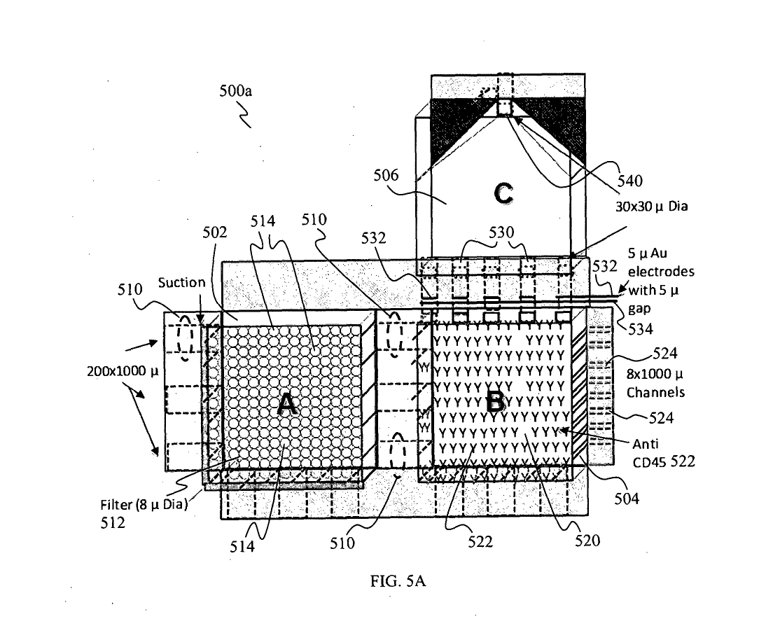

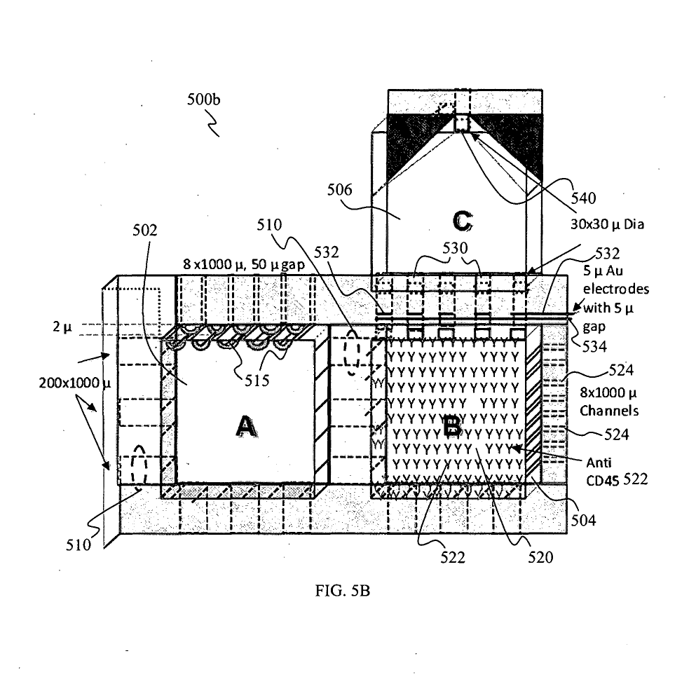

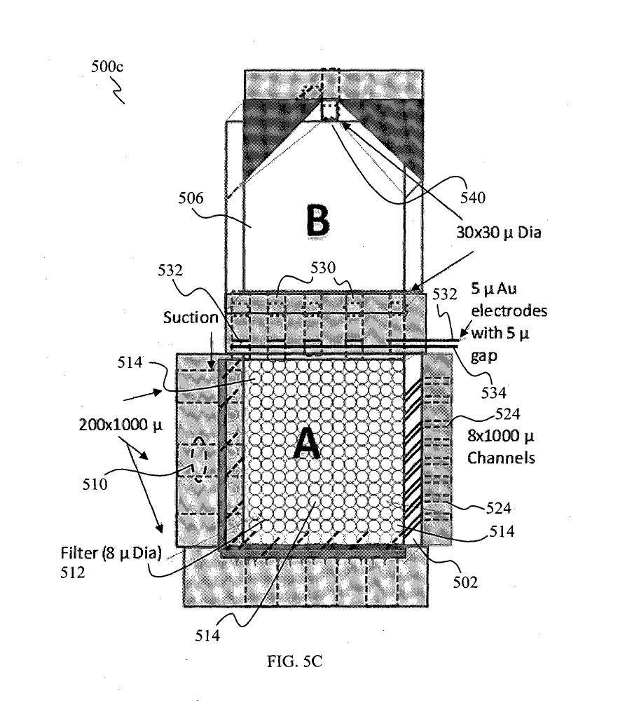

The integrated systems of various embodiments, which may be fully automated, will now be described by way of the following non-limiting examples, with reference to FIGS. 5A to 5C. Various embodiments may provide a fully automated integrated system of two to three chambers and a pre-enrichment system for enrichment and counting of cells. The integrated systems of various embodiments may be employed for the enrichment of circulating tumour cells (CTCs).

In various embodiments, a pre-enrichment system may be provided for or with the integrated systems of various embodiments, for example for blood sample transportation or storage and/or processing of blood sample prior to the integrated system of various embodiments. The pre-enrichment system may form part of (e.g. integrated) the integrated systems.

The pre-enrichment system may include multi-level anti-CD 45 coated micro channels and/or anti-CD45 coated magnetic beads, contained in a vertical tube with a back pressure system. Anti-CD 45 are white blood cell (WBC) specific, which may couple or bind to WBCs (leukocytes). The back pressure system may provide a suction force that may force or draw the blood sample through the pre-enrichment system, so that at least some WBCs may be removed from the blood sample by being attached to the anti-CD45 antibodies present within the pre-enrichment system. The use of a pre-enrichment system may help to remove a major portion of WBCs from the blood sample before the sample reaches to the main integrated system of various embodiments. The pre-enriched blood sample may then enter the integrated system for removal of red blood cells (RBCs) via filtration and lysing, followed by removal of left over or remaining WBCs so as to get purified circulating tumour cells (CTCs). All this pre-enrichment and integrated steps, in the pre-enrichment system and the integrated system, may be fully automated and may not be visible to the operator.

FIGS. 5A to 5C show schematic views of respective integrated systems 500a, 500b, 500c, for cell enrichment and counting, according to various embodiments. The integrated system 500a includes a first chamber (block A) 502 and a second chamber (block B) 504 in fluid communication with each other, for example either directly connected to each other or via one or more microchannels. In one embodiment, a plurality of microchannels, as represented by 510 for some microchannels, where each microchannel 510 has a diameter of about 200 μm and a length of about 1000 μm, may be provided for fluid communication between the first chamber 502 and the second chamber 504. For ease of understanding and clarity, only some microchannels 510 are shown in FIG. 5A. The microchannels 510 may also be used for suppling a sample volume (e.g. blood sample volume) to the first chamber 502. In various embodiments, the first chamber 502 and the second chamber 504 may collectively form a reservoir for receiving the sample volume, where depletion of RBCs and/or WBCs may be carried out so as to provide an enriched sample volume with predominantly CTCs.

The first chamber 502 may include a filter 512, which for example may be a parylene membrane containing photolithographically fabricated well-defined pores, as represented by 514 for three pores, distributed over a large area of approximately 3×3 cm². Each pore 514 has a diameter of about 8 μm. In further embodiments, the filter 512 may be a microfilter as described in the context of the embodiments of FIG. 1A to 1C, 2B, 3A, 3B, 3C to 3E, 4A, 4B or 4C. The first chamber 502 including the filter 512 may be used for removing at least some, if not all, of the RBCs and at least some or most of the WBCs (e.g. smaller WBCs) from the sample volume, based on size, by retaining CTCs on the filter 512 while passing RBCs and WBCs through the filter 512. Therefore, the integrated system 500a may result in the filtration of RBCs and WBCs in the first chamber 502, based on size.

Removal of the RBCs and WBCs from the first chamber 502 may be carried out using applied suction, for example via the use of a pump (not shown), under the parylene membrane 512 containing the pores 514 distributed over an area of 3×3 cm².

After filtering WBCs and RBCs in the first chamber 502, an enriched sample with predominantly CTCs and at least substantially depleted of WBCs, RBCs and other blood constituents (e.g. platelets) may be moved or transferred to the second chamber 504, for example via microchannels 510. In the second chamber 504, one or more surfaces or inner walls 520 of the second chamber 504 may be modified with surface markers (e.g. anti CD45), represented as letters ‘Y’ and by 522, which may be specific to WBCs (leukocytes), for capturing or trapping any left out or remaining WBCs from the enriched sample. Therefore, at least some of the WBCs present in the enriched sample, after filtration in the first chamber 502, may be removed from the enriched sample in the second chamber 504 using immuno assay.

A plurality of microchannels, as represented by 524 for some microchannels, where each microchannel 524 has a diameter of about 8 μm and a length of about 1000 μm, may be provided in fluid communication with the second chamber 504. For ease of understanding and clarity, only some microchannels 524 are shown in FIG. 5A. A suction force, for example via the use of a pump (not shown), may be applied through the microchannels 524 so as to remove any leftover or remaining WBCs and/or smaller cells from the second chamber 504 via the microchannels 524.

The enriched sample, which may be a solution with purified CTCs and at least substantially depleted of WBCs, after passing through the second chamber 504, may be passed or transferred to a collection or output chamber (block C) 506. A plurality of microchannels 530 may be provided in fluid communication with the second chamber 504 and the collection chamber 506. The microchannels 530 may be narrow channels of 30×30 μm² (30 μm width and 30 μm length). Each microchannel 530 may include a pair of electrodes (e.g. Au electrodes), for example a first electrode 532 and a second electrode 534. Each of the first electrode 532 and the second electrode 534 may have a thickness of about 5 μm. The first electrode 532 and the second electrode 534 may be spaced apart from each other by an interspacing distance of about 5 μm. As the cells, for example CTCs, flow from the second chamber 504 through the microchannels 530 towards the collection chamber 506, the flow of the cells over the first electrode 532 and the second electrode 534 may cause a change in impedance. The change in the impedance signal for cell passage over the first electrode 532 and the second electrode 534 in each channel 530 may provide label free counting, e.g. via electrochemical impedance spectroscopy (EIS), at multiple cell level with single cell precision. In other words, counting of cells may be carried out by measuring the electrical signal, in the form of impedance, via the first electrode 532 and the second electrode 534. The collection chamber 506 may be used for collection of purified CTCs after counting via EIS. The collection chamber 506 may further include an output microchannel 540, which may act as an outlet for transfer of the purified CTCs out of the integrated system 500a, for example for testing or to waste. The output microchannel 540 may allow passage of individual cells. For example, a single cell may pass out of the output microchannel 540 at any one time.

The integrated system 500b as shown in FIG. 5B may be similar to the integrated system 500a and may be as described in the context of the integrated system 500a, except that the first chamber 502 of the integrated system 500b includes 8 μm wide (diameter) 1D narrow channels, as represented by 515 for two channels, for the removal of RBCs and WBCs. Each channel 515 may have a length of about 1000 μm. The plurality of channels 515 may be spaced apart from each other by a 50 μm gap. For ease of understanding and clarity, only some channels 515 are shown in FIG. 5B. The integrated system 500b may result in filtration of some, if not all, RBCs and most of the WBCs (e.g. smaller WBCs) in the first chamber 502, based on size. The integrated system 500b may also remove WBCs in the second chamber 504 using immuno assay, which may be as described in the context of the integrated system 500a (FIG. 5A).

For the integrated system 500c as shown in FIG. 5C, the integrated system 500c includes a chamber (block A) 502 and a collection chamber (block B) 506 in fluid communication with each other, via a plurality of microchannels 530. In one embodiment, a plurality of microchannels, as represented by 510 for some microchannels, where each microchannel 510 has a diameter of about 200 μm and a length of about 1000 μm, may be provided for suppling a sample volume (e.g. blood sample volume) to the first chamber 502. For ease of understanding and clarity, only some microchannels 510 are shown in FIG. 5C.

The chamber 502 may include a filter 512, which for example may be a parylene membrane containing photolithographically fabricated well-defined pores, as represented by 514 for three pores, distributed over a large area of approximately 3×3 cm². Each pore 514 has a diameter of about 8 μm. In further embodiments, the filter 512 may be a microfilter as described in the context of the embodiments of FIG. 1A to 1C, 2B, 3A, 3B, 3C to 3E, 4A, 4B or 4C. The first chamber 502 including the filter 512 may be used for removing at least some, if not all, of the RBCs and at least some or most of the WBCs (e.g. smaller WBCs) from the sample volume, based on size, by retaining CTCs on the filter 512 while passing RBCs and WBCs through the filter 512.

The chamber 502 may also include magnetic beads tagged with anti-CD45 specific antibodies (not shown) for coupling to the remaining WBCs which have not been removed via filtration by the filter 512. These remaining WBCs may then be isolated or separated, via binding with the magnetic beads tagged with anti-CD45 specific antibodies mixed into the chamber 502, and by the application of a magnetic field, for example via a magnetic element (e.g. a permanent magnet) arranged adjacent at least a portion of the chamber 502.

Therefore, the chamber 502 may enable (i) RBCs and WBCs removal based on size via filtration, and (ii) anti CD45 coated magnetic beads incubation and capture of left over (remaining) WBCs using a magnet, based on immunomagnetic approach. As a result, most of the RBCs and WBCs may be removed in the chamber 502. Removal of the RBCs and WBCs from the chamber 502 may be carried out using applied suction, for example via the use of a pump (not shown), under the parylene membrane 512. Hence, an enriched sample volume with predominantly or purified CTCs and at least substantially depleted of WBCs and RBCs may be obtained. The enriched sample, being a solution containing pure CTCs, may then be passed or transferred to the collection or output chamber 506.

A plurality of microchannels, as represented by 524 for some microchannels, where each microchannel 524 has a diameter of about 8 μm and a length of about 1000 μm, may be provided in fluid communication with the chamber 502. For ease of understanding and clarity, only some microchannels 524 are shown in FIG. 5C. A suction force, for example via the use of a pump (not shown), may also be applied through the microchannels 524 so as to remove WBCs and/or smaller cells from the chamber 502 via the microchannels 524.

The microchannels 530 may be narrow channels of 30×30 μm² (30 μm width and 30 μm length). Each microchannel 530 may include a pair of electrodes (e.g. Au electrodes), for example a first electrode 532 and a second electrode 534. Each of the first electrode 532 and the second electrode 534 may have a thickness of about 5 μm. The first electrode 532 and the second electrode 534 may be spaced apart from each other by an interspacing distance of about 5 μm. As the cells, for example CTCs, flow from the chamber 502 through the microchannels 530 towards the collection chamber 506, the flow of the cells over the first electrode 532 and the second electrode 534 may cause a change in impedance. The change in the impedance signal for cell passage over the first electrode 532 and the second electrode 534 in each channel 530 may provide label free counting at multiple cell level with single cell precision. In other words, counting of cells may be carried out by measuring the electrical signal, in the form of impedance, via the first electrode 532 and the second electrode 534. The collection chamber 506 may be used for collection of purified CTCs after counting via EIS. The collection chamber 506 may further include an output microchannel 540, which may act as an outlet for transfer of the purified CTCs out of the integrated system 500c, for example for testing or to waste. The output microchannel 540 may allow passage of individual cells. For example, a single cell may pass out of the output microchannel 540 at any one time.

In various embodiments of the integrated systems 500a, 500b, 500c, the combination of pre-enrichment step and multiple chambers with size based and immuno/immunomagnetic method coupled with label free counting technique may have the potential to provide fully automated and highly efficient enrichment and precisely counted cells in viable state for further analysis via various optical, electrochemical etc. techniques. In various embodiments, it should be appreciated that the pre-enrichment step may be optional.

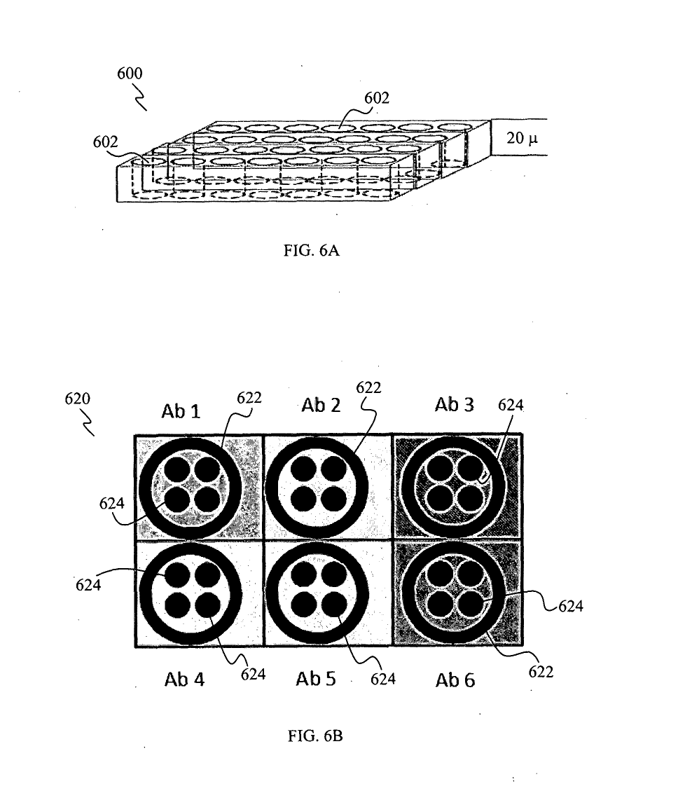

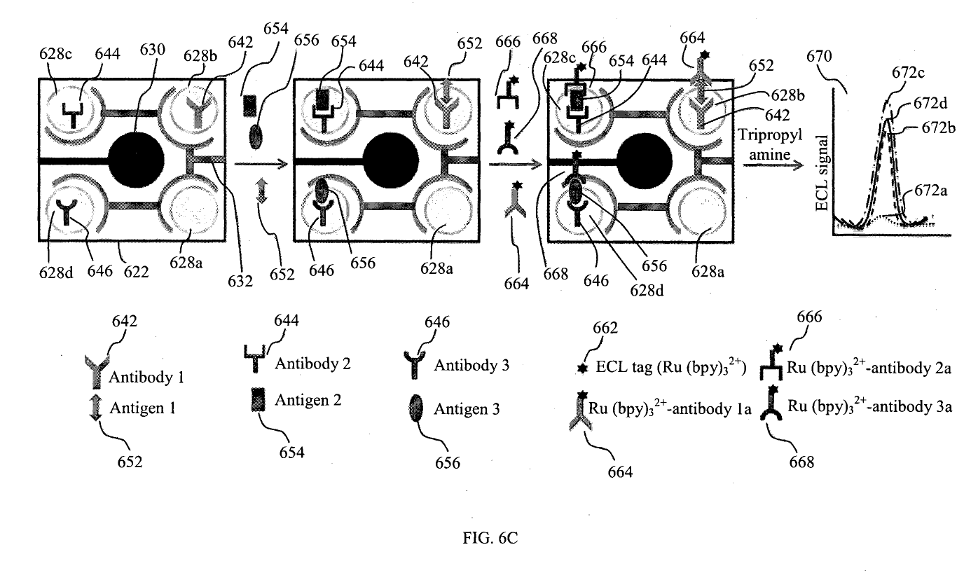

In various embodiments, individual cells, e.g. CTCs, collected from the integrated systems 500a, 500b, 500c, via the output microchannel 540 may be subjected to testing. For example, the cells may be collected in a tray (e.g. egg tray) 600 with a plurality of channels, as represented by 602 for two channels, as shown in FIG. 6A, for optical testing. The cells may also be collected in small holes with electrode for electrochemical testing. In various embodiments, the cells may be collected also for polymerase chain reaction (PCR) based testing, such as for telomerase activity.

In various embodiments, the cells may be collected in small pocket lyse for multi analyte immuno optical electrochemical assay, for example using an assay kit 620 as illustrated in FIG. 6B. The assay kit 620 may include pockets or wells 622 containing electrodes 624. As a non-limiting example, the cell lyses may be subjected to an electrochemiluminescent assay, as illustrated in FIG. 6C. FIG. 6C shows processing stages of an electrochemiluminescent assay, using, as a non-limiting example, a single well 622 with four working electrodes 628a, 628b, 628c, 628d, a counter electrode 630 and a reference electrode 632. As a non-limiting example, antibodies may be attached on each of the four working electrodes 628a, 628b, 628c, 628d. Different antibodies may be attached, for example antibody 1 642, may be attached to the second working electrode 628b, antibody 2 644 may be attached to the third working electrode 628c and antibody 3 646 may be attached on the fourth working electrode 628d while the first working electrode 628a is not attached with any antibody and to be employed as the control. Subsequently, antigen 1 652, antigen 2 654 and antigen 3 656 released from cells may interact with the attached respective antibody 1 642, antibody 2 644 and antibody 3 646 on the second working electrode 628b, the third working electrode 628c and the fourth working electrode 628d, respectively. Thereafter, complexes Ru(bpy)₃²⁺-antibody 1a 664, Ru(bpy)₃²⁺-antibody2a 666 and Ru(bpy)₃²⁺-antibody3a 668, where each contains an eletrochemiluminescence (ECL) tag Ru(bpy)₃²⁺ 662, may be utilized for binding with antigen 1 652, antigen 2 654 and antigen 3 656, respectively, which as a result may result in eletrochemiluminescence (ECL), for example as shown in the ECL intensity plot 670 as shown in FIG. 6C. The ECL intensities respectively labelled “672a”, “672b”, “672c”, and “672d”, correspond to the results of the control electrode 628a, the binding event of Ru(bpy)₃²⁺-antibody1a 664 with antigen 1 652 at the second working electrode 628b, the binding event of Ru(bpy)₃²⁺-antibody2a 666 with antigen 2 654 at the third working electrode 628c, and the binding event of Ru(bpy)₃²⁺-antibody3a 668 with antigen 3 656 at the fourth working electrode 628d.

Various embodiments of the integrated system may include a combination of two or three chambers for high efficiency, and/or may provide enrichment and counting at single cell level, and/or may allow capture of viable tumor cells (CTCs). The integrated system of various embodiments may provide complete removal of RBCs and WBCs using a multi-step approach on one platform, and/or counting of numerous cell individually at the same time, and/or enable separate cell availability for further analysis.

In various embodiments, the fabrication control for making reproducible micro pore structure, for the microfilters, in terms of size, shape and inter-hole spacing may be of critical importance to separate and filter the cells of interest at single cell level. In various embodiments, the fabrication process may involve multi level 200-500 μm pores or channels for blood flow and deposition of parylene membrane as a platform for the filter pores in the 3D structure and the integrated system. Next, deep ultraviolet (UV) photolithography may be used for patterning the micro-hole or pore structure to the specific size and pitch, and followed by reactive ion etching to produce through holes or pores in the membrane of the microfilter. Finally, gold deposition for electrode fabrication may be carried out. Standalone microfilters of various embodiments may be used with generally available systems, including syringe systems, whereas, fluidic encapsulation of the microfilters of various embodiments may be fabricated for integrated system. The design of the CTC enrichment and integrated label free counting, in terms of the microfilters and/or integrated systems of various embodiments, may have the potential to provide fully automated, easy, less labour intensive and cost effective technique for next generation cancer diagnostic tools.

As described above, various embodiments may provide a standalone 3D filter and/or a fully automated pre-enrichment and integrated system for efficient, cost effective and viable CTC enrichment and label free counting with single cell precision. A combination of fully automated pre-enrichment system and multiple chambers-based CTC enrichment may not be visible to the operator but also have the possibility to add another automated step for further analysis. Thus, the 3D filter and/or the fully automated CTC enrichment system may hold high potential to substantially improve the turn-around in the prognosis and diagnosis of cancer patients.

Various embodiments may be used for single cell level detection and analysis from body fluids and/or tissue samples for diagnosis and monitoring purposes, as well as CTC detection for cancer diagnostics, and maternal fetal cell based diagnosis. Clinical assay may be implemented based on the technology of various embodiments as described herein.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-25. (canceled)

26. An apparatus for separating a biological entity from a sample volume, the apparatus comprising:
a reservoir configured to receive the sample volume, the reservoir comprising a filter configured to separate the biological entity from the sample volume;
at least one of at least one magnetic element adjacent a portion of the reservoir, the magnetic element configured to provide a magnetic field in a vicinity of the portion of the reservoir to trap at least some leukocytes from the sample volume, or a layer comprising leukocyte specific biomarkers coated on at least a section of an inner wall of the reservoir, the leukocyte specific biomarkers configured to couple to leukocytes from the sample volume; and
a plurality of microchannels coupled to the reservoir, each microchannel comprising an electrode structure configured to measure a change in an electrical signal in response to a flow of the separated biological entity through the microchannel.

27. The apparatus according to claim 26, wherein the reservoir further comprises a plurality of magnetic beads couplable to leukocyte specific biomarkers configured to couple to the leukocytes from the sample volume.

28. The apparatus according to claim 26,
wherein the reservoir comprises a first chamber and a second chamber in fluid communication with each other,
wherein the first chamber comprises the filter, and
wherein the at least one magnetic element is arranged adjacent a portion of the second chamber and/or wherein the layer comprising the leukocyte specific biomarkers is coated on at least a section of an inner wall of the second chamber.

29. The apparatus according to claim 26, wherein the electrode structure comprises a first electrode and a second electrode spaced apart by a gap along a length of the microchannel.

30. The apparatus according to claim 29, wherein the gap between the first electrode and the second electrode is between about 1 μm and about 30 μm.

31. The apparatus according to claim 29, wherein each of the first electrode and the second electrode has a size of between about 1 μm and about 30 μm.

32. The apparatus according to claim 26, further comprising a pump coupled to the reservoir, the pump configured to provide a suction force.

33. The apparatus according to claim 26, further comprising an output chamber in fluid communication with the plurality of microchannels, the output chamber configured to receive the separated biological entity after filtration through the filter.

34. The apparatus according to claim 26, wherein the filter comprises a single porous layer comprising a plurality of pores, each of the plurality of pores having a dimension of between about 0.5 μm and about 30 μm.

35. The apparatus according to claim 26, wherein the filter comprises:
a first porous layer and a second porous layer arranged one over the other,
wherein the first porous layer comprises a plurality of first pores defined through the first porous layer,
wherein the second porous layer comprises a plurality of second pores defined through the second porous layer, and
wherein one or more respective second pores are arranged to at least substantially overlap with each respective first pore such that a respective opening defined between a perimeter of the each respective first pore and a perimeter of each of the one or more respective second pores is smaller than a diameter of each first pore.

36. The apparatus according to claim 35, wherein each second pore has a diameter that is smaller than the diameter of each first pore.

37. The apparatus according to claim 36, wherein the one or more respective second pores are arranged to be within the perimeter of each respective first pore.

38. The apparatus according to claim 26, wherein the filter comprises:
a plurality of first channels arranged in a first row; and
a plurality of second channels arranged in a second row adjacent to the first row,
wherein one or more respective second channels are arranged to at least substantially overlap with each respective first channel such that a respective opening defined between an edge of the each respective first channel and an edge of each of the one or more respective second channels is smaller than a width of each first channel.

39. The apparatus according to claim 38, wherein the filter further comprises:
a plurality of third channels arranged in a third row,
wherein the second row is arranged between the first row and the third row, and
wherein one or more respective third channels are arranged to at least substantially overlap with each respective second channel such that a respective opening defined between an edge of the each respective second channel and an edge of each of the one or more respective third channels is smaller than a width of each second channel.

40. The apparatus according to claim 26, wherein each of the leukocyte specific biomarkers comprises anti-CD45 specific antibodies.

41. The apparatus according to claim 26, wherein the layer further comprises an azide.

42. The apparatus according to claim 41, wherein the azide is 4-azidoniline hydrochloride or amino azide or aldehydic azide or epoxy azide or aromatic-fluoro-nitro azide.
